(19) United States
(12) Patent Application Publication
(10) Pub. No.: US 2019/0268214 A1
(43) Pub. Date: Aug. 29, 2019

(54) PREDICTING ISSUES BEFORE OCCURRENCE, DETECTION, OR REPORTING OF THE ISSUES

(71) Applicant: EntIT Software LLC, Sunnyvale, CA (US)

(72) Inventors: Stephane Herman Maes, Fremont, CA (US); Martin Bosler, Wannweil (DE); Srikanth Natarajan, Ft. Collins, CO (US)

(21) Appl. No.: 15/904,495

(22) Filed: Feb. 26, 2018

(51) Int. Cl. H04L 12/24; G06F 11/30; G06F 15/18; G06K 9/62

(52) U.S. Cl. CPC H04L 41/069; H04L 41/5074; G06K 9/6267; G06F 15/18; G06F 11/3006

(57) ABSTRACT

In some examples, a system uses machine learning to perform a classification based on a pattern in collected monitoring data and configuration data of an information technology (IT) system associated with an onset of an issue, the monitoring data collected during an operation of the IT system, and the configuration data representing an architecture of the IT system. The system predicts, based on the classification, the issue before the issue occurs or before the issue is detected or reported, and generates an indication of the predicted issue.

### BACKGROUND

An information technology (IT) system can refer to any system that includes system resources, in the form of hardware resources, software and/or firmware resources (which are machine-readable instructions such as applications, operating systems, boot programs, etc.), web resources, cloud resources, and so forth. Issues can arise in an IT system. In some cases, the issues can be handled by personnel at a support desk of an organization. In other examples, issues can be handled by an operations system associated with the IT system, where the operations system is able to automatically address the issues.

### BRIEF DESCRIPTION OF THE DRAWINGS

Some implementations of the present disclosure are described with respect to the following figures.

FIGS. 1A and 1B are flow diagrams of processes according to some examples.

FIG. 2A is a block diagram of an arrangement including an information technology (IT) system, an issue prediction system, and a remediation system, according to some examples.

FIG. 2B is a block diagram of an arrangement including an issue prediction system, a remediation system, an Information Technology Service Management (ITSM) system, and a remediation action automation system, according to further examples.

FIG. 3A is a flow diagram of a supervised learning process according to some examples.

FIG. 3B is a flow diagram of an unsupervised learning process according to some examples.

FIG. 4 is a block diagram of a storage medium storing machine-readable instructions according to further examples.

FIG. 5 is a flow diagram of a process according to additional examples.

FIG. 6 is a block diagram of a system according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Information technology (IT) service management (ITSM) can refer to activities performed by an organization (e.g., a company, an educational organization, a government agency, an individual, etc.) to plan, design, deliver, operate, and control IT services of an IT system offered to end users. An end user can refer to an individual, or to a group of individuals (e.g., employees of an organization or employees of a particular department of an organization).

The activities of an ITSM can be directed by policies and processes and supporting procedures of the ITSM. An ITSM system can provide support for handling issues that arise in the IT system. An “issue” can refer to a problem, an error, or any other condition or occurrence that an end user may perceive to be unsatisfactory.

In some examples, end users can report issues to a resolution entity associated with the IT system, where the resolution entity can include a self-service support desk, a ticket desk, or a call center support desk.

A call center support desk can include call agents that are able to receive calls or online chat requests from end users. The calls or online chat requests from end users are to report issues, and call center personnel at the call center support desk can help the end users address the issues, or can document the issues.

A self-service support desk can refer to an automated support desk, such as in the form of a support site (e.g., a website or any other remotely accessible server or system) that an end user can access. The support site can provide answers to frequently asked questions, or can provide support information in response to answers (provided by end users) to questions posed by the support site. The end users can use the answers to implement tasks to address respective issues.

A ticket desk refers to a site (in the form of a website or any other server or system) that is able to receive tickets that include information pertaining to issues encountered by end users. A ticket can refer to any collection of data that identifies a user or a machine or program associated with the issue, information pertaining to the issue that was encountered, and so forth. Each ticket can be transferred by the ticket desk to a corresponding specialist (or corresponding group of specialists), who can then address the ticket. A ticket may be produced based on information provided by an end user at a machine where the end user is located. Alternatively, a ticket may be produced by a call agent that collects relevant information pertaining to an issue from an end user. Ticket resolution can take place between different support desks (e.g., different levels of support or different organizations responsible for different parts or functions) through a process that can be referred to as case exchange.

In other examples, an IT system can include or be associated with an operations organization that performs administrative, monitoring, management, and maintenance tasks with respect to the IT system. The operations organization can use an operations system that can be implemented with a collection of computer(s) and administrative and maintenance tool(s), such as in the form of application(s) or other machine-readable instructions. Information relating to an issue can be provided to the operations system, which can then automatically perform tasks to address the issue.

In further examples, an operations organization can also operate independently or at least in parallel to an ITSM system (in the sense that the operations organization can perform its own monitoring of the IT system (or portion of the IT system), and based on the monitoring, the operations organization can decide to take some action (e.g., performing optimization, compliance checking, a security action, a cost management action, etc.) that is independent of or in addition to the action of the ITSM. The operations organization can also act and remediate issues that the operations organization observes as occurring or having occurred, and the operations organization can also act to prevent issues from occurring.

In some examples, to address an issue, the issue has to be first encountered by an end user and reported by the end user to a resolution entity before the issue can be addressed, or observed as having taken place by an operational team. As a result, since the end user has already encountered and reported the issue, the end user has experienced a loss of service and/or data, and may experience downtime (during which the user is unable to access the IT system) while the end user is waiting for resolution of the issue. This can lead to an unsatisfactory end user experience. Also, if a common issue is experienced by a large number of end users, then an organization can experience a large influx of issue reports that can burden the resources (computing resources as well as human resources) of the organization to address the reported issues.

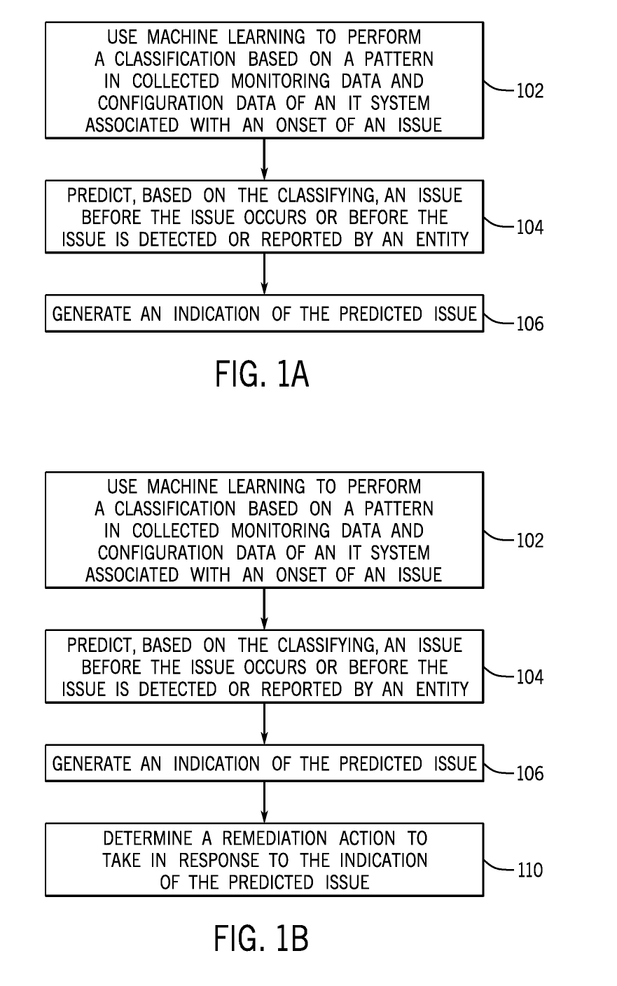

In accordance with some implementations of the present disclosure, an issue can be indicated and/or addressed before the issue occurs or before the issue is detected or reported by an end user or any other entity (whether a human entity, a machine, or a program) like for example monitoring systems of the operational team. In some examples, as shown in FIG. 1A, a process uses (at 102) machine learning to perform a classification based on a pattern in collected monitoring data and configuration data of an IT system associated with an onset of an issue.

An “onset of an issue” refers to an initial occurrence of precursors that announce or otherwise indicate the issue. A “precursor” can refer to any event or artifact or data that provides an indication that the issue will occur. A precursor can be in the form of a pattern (e.g., a multidimensional pattern) occurring at a given time. Alternatively, a precursor can be in the form of sequences of data, such as a time series of data. The monitoring data and configuration data associated with the onset of the issue refers to a portion of the overall monitoring data and configuration data that occurs during a time period ahead of the issue, where the monitoring data and configuration data can relate to any location (e.g., geographic location, a network, a server rack, a storage rack, etc.). More generally, the monitoring data and configuration data associated with the onset of the issue refers to a portion of the overall monitoring data and configuration data that shares some attribute (or attributes) with the root cause(s) or manifestation(s) of the issue as well as the observation of the issue. In the monitoring and configuration data, location-related fields such as a network address (e.g., Internet Protocol or IP address), a server name, etc., can be filtered out as part of the analysis, so that monitoring and configuration data from many locations can be used.

Monitoring data is collected during an operation of the IT system. Configuration data enables an extraction of a representation of an architecture of the IT system (or a portion of the IT system) under consideration (e.g., a topology or stack of items that are related and form an application or service).

The monitoring data can include data collected by various monitoring agents (e.g., hardware sensors, software agents in the form of machine-readable instructions, etc.). Alternatively, the monitoring data is not collected by agents, but rather can be provided by programs or machines during execution or with agentless monitoring like Micro Focus SiteScope. The monitoring data can include data relating to at least one selected from among data of an (pre-processed or raw) event in the IT system (or a portion of the IT system), data of a metric measured in the IT system (or a portion of the IT system), or a log of the IT system (or a portion of the IT system). An event can refer to an activity that occurs in the IT system and that triggers an operation in the IT system. Pre-processing may reflect filtering and correlation rules to remove spurious and duplicated events. A metric can refer to any parameter (or collection of parameters) that can be measured from the infrastructure, platform, or application layers. A log can refer to a data structure (e.g., a file, a database, etc.) into which data relating to the IT system has been captured and can be stored for later retrieval.

The monitoring data can include any or some combination of operation data, usage data, security data, compliance data, and so forth. Operation data refers to data that relates to operation and health of a system resource. Usage data refers to usage of a system resource, such as how often the system resource is used, by which entity the system is used, cost of the usage (to allow showback or chargeback), billing information (i.e. the cost incurred by using the systems, resources etc.), and so forth. Security data refers to a security aspect of use of a system resource, such as whether any violations of a security protocol has occurred as well as intrusion, hacking, compromising or attack signs. Compliance data refers to compliance with a rule during use of a system resource, such as compliance with a rule set by the organization, a government regulation, and so forth.

Configuration data of an IT system can include data that represents system resources (e.g., hardware resources, software resources, a stack (e.g. an operating system, middleware, applications), firmware resources, etc.) of the IT system, and a topology of the IT system. A topology of the IT system refers to a manner in which the system resources are arranged, and how the system resources relate to one another (e.g., whether the system resources are physically linked to one another, whether system resources are able to communicate with one another, whether a first system resource includes or contains a second system resource, or whether an operation of a first system resource affects an operation of a second system resource). Additionally, the configuration data can include data that represents a setup of the system resources. A setup of a system resource can refer to how the system resource is configured to operate, for example. In some examples, configuration data of an ITSM system, information technology operations management (ITOM) system, or IT infrastructure library (ITSL) can be tracked by a configuration management system (CMS) or in a configuration management database (CMDB). These system can be built in any or some combination of the following different ways: 1) a system can be populated manually, 2) a system can be discovered with systems, such as using the Universal Discovery tool from Micro Focus or other tools from other vendors, or 3) a system can be populated by day-1 provisioning systems like the Hybrid Cloud Management (HCM) tool or the Cloud Service Automation (CSA) tool from Micro Focus, or other tools from other vendors, 4) a system can be what has been provided to a monitoring system for tracking, or 5) a system may be updated when it is modified.

During operation of the IT system, the configuration data can change. Changes in the configuration data can relate to changes to the system resources, changes in the topology of the system resources, and/or changes in the setup of the system resources. These changes may be initiated by a ticket in an ITSM system and documented there. The changes may also result from problems tracked in the ITSM system (e.g., tickets and their resolution) and/or result from day-1 provisioning or operational day-2 management tasks, or changes may sometimes by automated like done using a Platform as a Service (PaaS) or a Container as a Service (CaaS).

A “pattern” in data (over time) can refer to any recognizable combination of values of a metric (or multiple metrics), and/or an event (or multiple events), and/or logged data, and/or configuration data, where the recognizable combination of values can recur given a particular condition (or conditions) of the IT system. The pattern can manifest also in multi-dimensional time series, where time is a possible dimension in the pattern.

Machine learning can refer to techniques where an automated engine can be trained to perform a task, which according to some examples is the task of classifying based on patterns. For example, based on input data, the automated engine can perform a classification of whether or not the input data is positive or negative with respect to a class (or multiple classes). In some examples, the class for which the automated engine is trained can be whether a specific pattern is present or not in the input data, or alternatively, whether or not a precursor (or multiple precursors) of an issue is present. The automated engine can be in the form of machine-readable instructions executable on a computer processor. Instructions executable on a computer processor can refer to instructions executable on a single computer processor or instructions executable on multiple computer processors.

The process of FIG. 1A further predicts (at 104), based on the classifying, an issue before the issue occurs or before the issue is detected or reported by an entity (e.g., an end user, another user, a machine, a program, etc.). The prediction of the issue can be performed using machine learning. For example, a trained automated engine can detect presence of a particular pattern during an operation of the IT system, and can use the detected particular pattern as an indicator that the corresponding issue is about to occur. In some examples, a pattern can be present across multiple dimensions at a given time. In other examples, a pattern can be present in a time series of vector data, where the pattern can be exhibited in data occurring at different times. It is noted that the pattern detected by the automated engine may not be explicitly identified. The pattern may be something that can be recognized by an internal classifier of the automated engine, but the pattern may not be explicitly indicated.

Next, the process generates (at 106) an indication of the predicted issue. The indication can be in the form of a notification, a report, a message, or any other information element that can be sent to a target, such as a human or another entity including a machine or a program. In response to the indication, the target can address the predicted issue, or can forward the indication of the predicted issue to another entity for resolution (e.g., an automated remediation system). The information that can be added may encompass information about the nature of the issue or any other information that the system may have also assembled or correlated (like root cause candidates or past resolutions, etc.). This can also be done by the system reacting to the initial prediction.

FIG. 1B is a flow diagram of a process according to further examples. Tasks 102, 104, and 106 are similar to the tasks of FIG. 1A. The process of FIG. 1B further determines (at 110) a remediation action to take in response to the indication of the predicted issue. The determined remediation action can include selecting a remediation strategy from multiple different remediation strategies. Alternatively, a remediation action can be built, and the built remediation action can be automated and performed in response to the predicted issue. Information relating to a remediation action to take can also be included in the indication of the predicted issue, so that the remediation action included in the indication can be performed. Including information of the remediation action in the indication can allow for a fully autonomous system to automatically perform the remediation, or the information can help an operations organization or an ITSM service desk to resolve the predicted issue. Note the indication can also be used to initiate other type of actions, such as inviting participants to a war room meeting or to an online chat session (e.g., using ChatOps) involving multiple participants, where information of the predicted issue, information of the root cause of the predicted issue, information of a possible resolution, and/or a past history relating to the predicted issue can be provided as input to the meeting or chat.

In FIG. 1A or 1B, in some examples, the indication of the predicted issue (task 106) can be entered or in the form of a ticket into an ITSM system, where the ticket can be: 1) for an issue that has not yet occurred or for a root cause that has occurred, or 2) for an issue that may have occurred but nobody has noticed yet and hence has not yet created the ticket.

By using machine learning to perform classification based on a pattern and predict an issue based on the classification before the issue occurs or before the issue is detected or reported, customer experience can be improved. Also, resources (system resources and/or human resources) expended to address issues can be reduced, such as by avoiding a flood of issue reports when a large number of end users encounter a common issue. In addition, by being able to predict an issue and implement a remediation of the predicted issue, cost savings (cost of down time and cost of investigating issue, supporting customers and remediating) and customer experience can be improved.

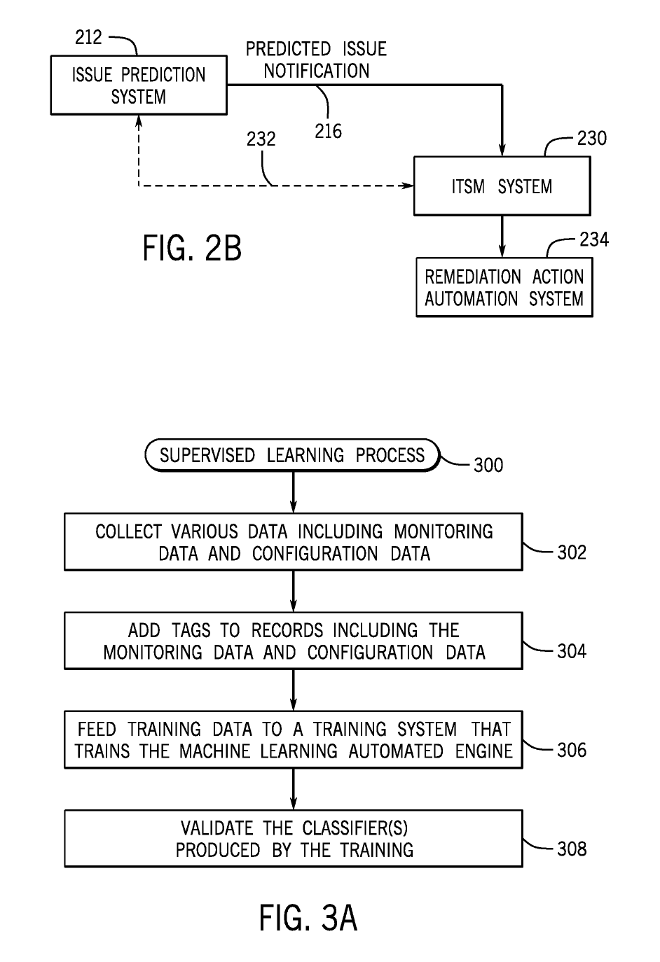

By using machine learning, the prediction of the issue does not merely monitor a metric (or multiple metrics) and concluding that an anomaly has occurred if the value(s) of the metric(s) move outside a specified percentage of standard deviation from a mean. or if an extrapolated value would do something similar. Techniques according to some implementations of the present disclosure can use machine learning, not just anomaly detection, to apply classification based on a pattern across a larger number of issues as well as across complex arrangements of system resources of an IT system. By using machine learning, an issue prediction system is able to learn (as explained further below in FIGS. 3A and 3B and other passages) the patterns that the issue prediction system is supposed to look for to predict an issue. As a result, an issue prediction system according to some implementations of the present disclosure can use the learned patterns that does not rely on just determining if metric value(s) (or predicted/extrapolated values) move a specified percentage of standard deviation from a mean. In traditional anomaly detection approaches, it can be difficult for a system to determine what to look for, particularly if there are a large number of metrics or the IT system is complex. By learning (using supervised and then unsupervised training of) the pattern that is indicative of an issue, the issue prediction system according to some implementations is able to determine which of a large number of metrics is (are) relevant, along with other information (such as events, logs, configuration data, etc.). Also discussed further below, the learning can include first performing supervised learning followed by unsupervised learning. Thus, the predicting of an issue performed according to some implementations of the present disclosure is not detection that is merely based on misbehavior of a monitored metric (or metrics), but rather based on machine learning that determines a pattern in collected monitoring data and configuration data of the IT system.

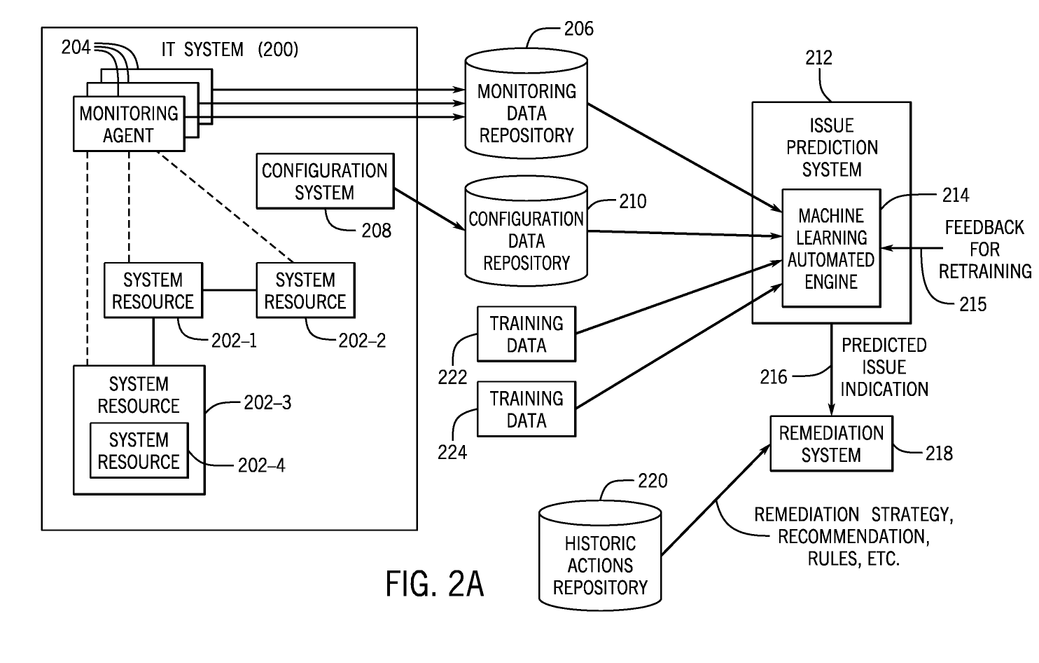

FIG. 2A is a block diagram of an example arrangement according to some implementations of the present disclosure. Although FIG. 2A shows an example arrangement, it is noted that in other examples, other arrangements can be used. An IT system 200 includes various system resources 202-1, 202-2, 202-3, and 202-4. Although a specific number of system resources are depicted in FIG. 2A, it is noted that in different examples, a different number of system resources may be present in the IT system 200. Links among the system resources 202-1, 202-2, and 202-3 can indicate that the system resources are physically connected to one another, or are able to communicate with one another, or whose operations affect one another. Additionally, the system resource 202-3 includes the system resource 202-4 (e.g., the system resource 202-4 is an application executable in a computer represented by the system resource 202-3).

In some examples, the IT system 200 includes monitoring agents 204 that are able to monitor operations of the system resources 202-1 to 202-4, or of groups of system resources. Monitoring data collected by the monitoring agents 204 based on the monitoring of the (groups of) system resources are stored in a monitoring data repository 206, which can be implemented with a storage device or a collection of storage devices. In further examples, the monitoring agents 204 can omitted, and some of the monitoring data can be obtained in an agentless manner (such as by accessing the monitoring data through an application programming interface) or supplied by end users or other systems rather than by the monitoring agents 204. Monitoring data can refer to any type of data, including operations data, security data, usage data, cost data, compliance data, and so forth.

The IT system 200 further includes a configuration system 208 that can manage a configuration of the system resources 202-1 to 202-4 of the IT system 200, including the setup of the system resources and/or the configuration of a topology of the system resources.

The configuration system 208 can track a topology in any or some combination of the following ways. The configuration system 208 can include a discovery system that probes an IT system to discover system resources of the IT system. This discovery may be aided by artificial intelligence (AI).

In further examples, the configuration system 208 can obtain information relating to provisioning (day-1 operation) of an IT system, in which case the day-1 information can include information relating to provisioning of system resources of the IT system.

In additional examples, the configuration system 208 can obtain metadata including information compiled in enterprise architecture systems that document different system resources of an enterprise.

In yet further examples, the configuration system 208 can obtain information relating to management (day-2 operation) of system resources of an IT system. Further, the configuration system 208 can obtain updated information obtained by day-2 management, such as when scaling or moving workloads and so forth.

The configuration system 208 may also obtain information due to changes responsive to tickets or updates documented in tickets in ITSM, remediation or changes performed using an automated script or by a manual system, and so forth.

The configuration system 208 stores the configuration data of the IT system 200 in a configuration data repository 210, which can be implemented with a storage device or a collection of storage devices. Examples of the configuration data repository 210 can include any or some combination of a CMDB, a data repository of a CMS, a data repository of a Real time System management (RTSM) system, and so forth. In alternative examples, both the configuration data and the monitoring data can be stored in a type of data lake that is shared across many different systems. Mechanisms can collect data and store the data in the data lake, against which analytics can be performed. The data in the data lake can be used for prediction, which can be performed in real time. The stored data in the data lake can be used in the future for further learning (supervised and/or unsupervised training). ITSM data and CMS data can be similarly stored. The data can be time alignable (e.g., via timestamps).

The monitoring data and the configuration data can be accessed by an issue prediction system 212 from the monitoring data repository 206, the configuration data repository 210, and/or from any other source(s). For example, in a real time system, another mechanism can be used to obtain the data as the data is streamed, e.g., from Apache Kafka or another tool, while at the same time the data is written into repositories. In some examples, the issue prediction system 212 can query the monitoring data and the configuration data, or alternatively, the issue prediction system 212 can subscribe to the data and receive the data, such as in a stream or by push notifications. The issue prediction system 212 includes a machine learning automated engine 214 that can classify data based on a pattern in the monitoring data and the configuration data and can predict an issue based on the classification, as discussed above. The issue prediction system 212 can be implemented using a computer or an arrangement of multiple computers, and the machine learning automated engine 214 can be implemented as machine-readable instructions executable in the issue prediction system 212.

In some examples of the present disclosure, the monitoring data and configuration data used for issue prediction can be stored in an unstructured format in the respective repositories 206 and 210 (i.e., no specific schema has to be defined regarding the form of the data being considered by the issue prediction system 212). In this manner, an organization does not have to predefine a schema for the monitoring data and configuration data to use in issue prediction, which eases implementation of the issue prediction system 212 and enhances flexibility since the issue prediction system 212 can be applied to data in any of various different formats. Note that training data for training the issue prediction system 212 can be tagged, such as by tagging the monitoring data and configuration data with time information relating to time points of the issues. Adding the time information can allow for time alignment of the data. In general, it is useful to know when issues have taken place with respect to the monitoring data (when they occurred or when they were detected, reported, and/or remediated). Any timing information can be used in the monitoring and the configuration data. In further examples, the mining of ITSM data and tickets can be automated. If such data are time aligned, it is possible to mark when a ticket about a certain issue was created. This reduces intervention of a human expert to train the system and allows for unsupervised training also.

The issue prediction system 212 provides an indication 216 of a predicted issue to a remediation system 218. Alternatively or additionally, the indication 216 can be sent in a notification to a user, or in a message to an online chat room or a chat bot, possibly with instructions first to set up the chat room and invite participants. Note that the indication 216 of the predicted issue can also include a timestamp.

In some examples, the remediation system 218 can be an autonomous remediation system that can automatically address the predicted issue, without human intervention or with reduced human intervention. In some examples, the remediation system 218 has access to a historic actions repository 220 that contains data representing actions that have previously been taken to address corresponding issues detected in the past. To address a predicted issue, the remediation system 218 can access the historic actions repository 220 to identify a matching issue to the predicted issue, and retrieve information pertaining to the matching issue from the historic actions repository 220. A matching issue can refer to an issue that is the same as the predicted issue, or that is similar to the predicted issue based on a matching criterion that can include an attribute or multiple attributes of issues that is (are) compared to determine whether multiple issues are similar. Note that multiple issues can be similar even though they differ in some attribute(s), such as a network address (e.g., an Internet Protocol or IP address). The remediation system 218 can learn to distinguish between attribute(s) that is (are) invariant across the same issue, and attribute(s) that can change. Data can be prepared and annotated to remove such information from being classified or processed by the machine learning system.

The retrieved information pertaining to the matching issue from the historic actions repository 220 can include information of actions taken in the past to address the matching issue, and the resolution status of the past actions. The resolution status can indicate success (i.e., the past action(s) successfully addressed the matching issue), failure (i.e., the past action(s) failed to address the matching issue), or partial success (i.e., the past action(s) partially addressed the matching issue).

The retrieved information can also include a remediation strategy or a recommendation for a remediation action. Further, the retrieved information can include information to enable automation of the remediation (which can include parameters that may be changed and that were used in past as part of automating the remediation).

In further examples, the retrieved information can include heuristic rules that have been prepared for certain situations by matching the root cause to these situations. A heuristic rule can identify a root cause given a specific situation (or situations) relating to the predicted issue.

In other examples, the remediation system 218 can combine multiple pieces of information, such as those listed above, to generate a new remediation recommendation or to perform automation.

In other examples, a system separate from the remediation system 218 can add any of the foregoing pieces of information.

In some examples, the remediation system 218 can also be implemented with an AI system to aid in creating new remediation actions and associated automations of the new remediation actions. The training of the AI based remediation system 218 can be achieved by providing the reasoning (in the form of examples) on how implemented remediation of actual problems have been determined as well as how the implemented remediation actions are mapped to automation. With enough examples the AI based remediation system 218 can learn to build remediation actions and associated automations in supervised ways.

A remediation action can be selected by the AI based remediation system 218 based on historical information indicating that a given issue has been resolved (i.e., becomes absent) once the remediation action was applied, and no new issue(s) arose based on application of the remediation action. The absence of the given issue and any new issue(s) associated with application of the remediation action provides a positive reinforcement for the AI based remediation system 218. However, the presence or occurrence of either or both of the given issue or new issue(s) in response to application of the remediation action provides a negative reinforcement for the AI based remediation system 218, which would lead the AI based remediation system 218 to tend not to select the remediation action for the given issue.

In other examples, the remediation system 218 can represent a tool (or tools) that can be used by a human to address the predicted issue. In some examples, a notification can be sent to an operator who can then determine what to do with the predicted issue. Alternatively, the notification can also include a recommended remediation action of what to do in order to remediate the predicted issue, and the operator can apply the recommended remediation action guided by that information. In other examples, a notification can include a recommended remediation action (or multiple remediation actions) and associated to automation information (e.g., information to trigger a script or flow to implement the recommended remediation action). The operator can approve the triggering of the automation of the remediation action, or the operator can select the remediation action to apply. For example, the foregoing can be performed in an online chat room possibly with one or multiple bots also present, such as by using ChatOps, where the bot(s) can execute a script or another automation artifact. Eventually, a notification can be used to perform, manually or automatically, remediation actions to address new tickets so that an issue can be prevented or addressed by resolving the ticket. No matter what, what the user does is recorded to be played back or used to train (supervised or unsupervised) the prediction (e.g., did the user do something, did the problem occur without doing anything, did doing system make the problem not occur, etc.) and the remediation systems (e.g., what was done in such circumstances and how was it done).

In the context of ITSM, predicting an issue can refer to predicting an incident, such as an incident that can be reported in a ticket. Thus, in accordance with some implementations of the present disclosure, the predicted incident that can be represented by a ticket is an incident that has not yet occurred or has not yet been detected or recorded by an entity. In this manner, the incident represented by the ticket can be reported and/or resolved by the remediation system 218 before the incident occurs or before the incident is detected or reported.

In some examples, the remediation system 218 can apply remediation of the predicted without going back to the ITSM system, just like the operations team can be informed and act without a ticket, although the operations team can create a ticket thought.

In other examples, as shown in FIG. 2B, the issue prediction system 212 can predict an issue, and the predicted issue indication 216 is sent (such as by calling through an application programming interface, sending a notification, etc.) to an ITSM system 230. The predicted issue indication 216 may be entered into the ITSM system 230, such as in the form of a ticket. The ITSM system 230 can in turn interact (at 232) with the issue prediction system 212 to obtain information (e.g., root cause) of the predicted issue and to determine who is able to address the predicted issue. In some examples, the ITSM system 230 may identify an ITSM help desk or an operations team or other entity to pick up the ticket to perform remediation of the predicted issue. Alternatively, the ITSM system 230 can invoke a remediation action automation system 234 to automate a remediation action to address the ticket.

In examples where the ticket is sent by the ITSM system 230 to an operations team, the operations team can manually, using a script or other automation entity, remediate using the information received from the issue prediction system 212. In some examples that involve cloud workloads that have been deployed via a cloud controller (e.g., a Hybrid Management Cloud or Cloud Service Automation tool from Micro Focus), the operations team can also use lifecycle management actions provided by the cloud controller to remediate when notified of the predicted issue.

The predicted issue can be addressed by the remediation system or process before the actual issue occurs. In some cases, the predicted issue can be fully resolved before the issue occurs, so that end users do not experience the issue at all. In other examples, while the predicted issue is being addressed, the issue can actually occur and be encountered by end users. Even in this latter case, by starting the resolution of the issue before the issue is encountered or detected or reported by an entity, the issue resolution process may be started earlier and thus potentially resolved earlier (e.g., to reduce a downtime for an end user), and further, the ITSM system or operations system is aware that the predicted issue may occur such that any subsequent issue reports received for the issue can be grouped into the resolution process.

In addition to predicting an issue before the issue occurs or before the issue is detected or reported, the issue prediction system 212 and/or the remediation system 218 can also predict an expected time to resolution of the predicted issue. This can be based on past occurrences of a matching issue, as represented by the historic actions repository 220. The historic actions repository 220 can maintain, for past issues, amounts of time involved in addressing each such past issue. Data of the past issues can be selected from among ITSM data, configuration management system (CMS) data, data of a configuration management database (CMDB), or an operations log (log of data collected during operation of a system). Based on the amount of time information in the historic actions repository 220, the issue prediction system 212 and/or the remediation system 218 can predict an expected time to resolve the predicted issue.

Additionally, in some examples, the issue detection system 212 and/or the remediation system 218 is able to predict when the predicted issue may appear. Again, this can be based on logged information (in the historic actions repository 220) that indicates a relationship between values of monitoring data and configuration data and when an issue can arise based on the values of monitoring data and configuration data. For example, certain events may first occur before the issue occurs. The logged information in the historic actions repository 220 can include a log of such prior events, and information regarding how long after such events have occurred before the same issue or a similar issue arose.

The remediation system 218 can also provide a recommendation to address the issue, including any task relating to a remediation of the issue. The remediation can involve a human, or alternatively, can be performed automatically by a machine or a program.

In some examples, the remediation that is recommended can address any service level agreement (SLA) associated with an end user that may potentially encounter the predicted issue. The actions to address the predicted issue can ensure or increase the likelihood that the SLA is met. For example, an SLA can specify that a user is guaranteed to not have a downtime greater than X minutes. The actions provided in the recommendation from the remediation system 218 can ensure or increase the likelihood that service of the IT system 200 is restored to the end user within X minutes.

Additionally, the issue detection system 212 and/or the remediation system 218 can also identify a root cause of the predicted issue. Determining a root cause of a predicted issue can refer to determining a program, machine, or activity that led to the predicted issue.

In some examples, the monitoring data and the configuration data that can be collected includes timestamped data. By timestamping the monitoring data and the configuration data, the issue prediction system 212 is able to time-align the data, so that the issue prediction system 212 can establish a temporal correlation between the monitoring data and the configuration data when detecting patterns.

Machine learning implemented by the machine learning automated engine 214 can be based on performing any or some combination of the following: pattern matching, deep learning, artificial intelligence, and so forth. An initial training of the machine learning automated engine 214 can be supervised. Supervised training refers to tagging training data 222 with information relating to whether or not the training data is indicative of a given issue. For example, the training data 222 can include multiple records, where each record includes values of multiple attributes of the monitoring data and configuration data.

FIG. 3A shows a supervised training process 300 performed by the machine learning automated engine 214 according to some examples. The supervised training process 300 collects (at 302) various data, including monitoring data that is timestamped (i.e., each record of the monitoring data includes a respective timestamp). The monitoring data can include data from an ITSM system (ITSM data) as well as any of the monitoring data discussed above. The collected data also includes configuration data that is timestamped. The supervised training process 300 adds (at 304) tags to the records including the monitoring data and the configuration data for indicating that the attributes in the respective records are indicative of a corresponding issue. The tags assigned to the records of the training data (including the monitoring data and configuration data) can be set by a human (or group of humans) or by other entities, including machines and/or programs. Automated assignment of tags can be based on, for example, mining ITSM data (including tickets) that is timestamped to identify issues. The identified issues can then be used to assign tags to time-aligned monitoring data and configuration data. A tag can identify an issue type or an issue and associated metadata. In other examples, other techniques or mechanisms can be used to assign tags. Note also that changes in configuration can be an indication of an issue, which can be used to assign a tag. In some examples, the collected data can be processed and filtered to remove deployment or location or machine specific information (e.g., server name or IP address) and replaced by generic placeholders, unless the machine learning algorithm includes dimension reduction functionality to perform the filtering automatically.

The configuration data is provided to ensure that the data used to train for an issue or type of issue is associated with a particular configuration or similar configuration. By using the configuration data, the machine learning automated engine 214 can learn how to partition the monitoring data according to respective different configurations.

The training data including the tagged monitoring data (and possibly the tagged configuration data) for a given time window (or multiple time windows), where each time window can range from several minutes to several hours or more, preceding a particular issue is fed (at 306) to a training system that trains the machine learning automated engine 214 for classifying monitoring and configuration data as predictive of the particular issue. The training of the machine learning automated engine 214 provides a classifier (or multiple classifiers) in the machine learning automated engine 214 that is able to classify monitoring and configuration data to predict the particular issue.

Any training data not used to train the machine learning automated engine 214 as part of supervised training can be used to validate (at 308) the classifier(s) produced by the training. Validating the classifier(s) refers to determining whether the classifier is correctly classifying data to predict an issue, or if the classifier was incorrectly predicting an issue or missing an issue.

Once trained and validated using the supervised training process 300, the classifier of the machine learning automated engine 214 is ready to process in real time a stream of monitoring and configuration data for predicting an issue.

In some cases, multiple classifiers in the machine learning automated engine 214 can be trained for different time windows (i.e., a time window refers to how far in advance of an issue a collection of monitoring and configuration data having certain attribute values will indicate a possible onset of the issue). A stream of monitoring and configuration data can be provided in parallel to the classifiers to predict the particular issue for the different time windows. The outputs of the classifiers can be combined in some manner, such as by using a voting technique where if a majority of the classifiers predicts the particular issue, then that produces an output indicating that the particular issue is predicted.

Note that configuration data can be used not only to partition the monitoring data space per related configuration, but the configuration data can also be used for training or prediction. In some cases, a change in configuration of a system can be due to a new issue. A configuration change may provide an indication that an issue is about to occur, and an operations system took action to prevent the issue. If a configuration change occurred and no issue is detected after the configuration change, then that can indicate that the configuration change was successful in resolving or preventing an issue. If a configuration change occurred when an issue is predicted and the issue did not actually occur and no other related issue occurred, then that indicates the configuration change is positive. The training of a classifier to predict issues can be based on the change in configuration for the issue.

Once the machine learning automated engine 214 has been initially trained using supervised learning based on the training data 222, an unsupervised learning process 320 (FIG. 3B) can then be performed by the machine learning automated engine 214 using additional data and/or data obtained during operation of an IT system. The machine learning automated engine 214 can continue (at 322) to monitor both the monitoring data and the configuration data and ITSM data acquired during operation of the IT system 200. The machine learning automated engine 214 can receive (or determine) (at 324) feedback regarding whether or not actual issue predictions made by the machine learning automated engine 214 has been indicated as a false positive (the machine learning automated engine 214 predicted an issue based on the monitoring and configuration data and the prediction was wrong), a false negative (the machine learning automated engine 214 did not predict an issue based on the monitoring and configuration data when the machine learning automated engine 214 should have), or a correct prediction (the issue predicted by the machine learning automated engine 214 was correct). The feedback can be received from an operations organization for example, who can indicate whether or not the operations organization agrees with issue predictions made by the machine learning automated engine 214. The determination of feedback can be based on using the time-aligned monitoring data and configuration data and ITSM data or changes in a CMS or any other log that tracks the operations of the IT system.

The feedback can be used by the machine learning automated engine 214 to continually improve (at 326) the predictions made by the machine learning automated engine 214 (by retraining, as indicated by feedback 215 in FIG. 2A), in an unsupervised manner since tagged training data is not used for the training. In unsupervised training false positive and false negative versus correct predictions are determined to positively reinforce or negatively reinforce the system. A store of accumulated historical data can also be used to retrain the system to detect what it missed and avoid false alarms.

In some examples, the approach of using feedback to continually improve the machine learning automated engine includes: 1) reinforcing the learning when a predicted issue is acted upon (manually or automatically), especially if the type of issue predicted did not occur, 2) penalizing the learning if the predicted issue is not acted upon and the issue did not occur, 3) reinforcing the learning if the predicted issue is not acted upon but the issue occurred. The feedback information is obtained from what is performed or observed in the ITSM and/or CMS system, for example, or from a remediation system, or from manual flagging or rating of the prediction by operations or service desk specialists. Reinforcing a learning by the machine learning automated engine refers to a positive reinforcement of a prediction made by the machine learning automated engine. Penalizing a learning by the machine learning automated engine refers to a negative reinforcement of a prediction mad by the machine learning automated engine.

By performing the unsupervised training, any issues that were previously missed by the machine learning automated engine 214 can be learned by the machine learning automated engine 214. Moreover, a false positive can be detected based on determining that an operations team did nothing to address a predicted issue.

In addition, remediation actions can be learned for the predicted issues. A remediation action that results in no further issue immediately appearing is an indication that the remediation action was successfully, which provides positive reinforcement that the remediation action worked.

The unsupervised learning provides a way to learn to predict (and possibly remediate) new issues. If an issue that was not previously encountered occurs, such issue can be handled in an unsupervised manner since the machine learning automated engine 214 is learning to handle the new issue.

In this manner, new issues are learned or discovered as time goes by. By using ITSM data, tickets classified for a new issue can be used to add the ability to predict this issue. This would be done by periodic retraining on historical data. For example, issues tags can come from similar ITSM tickets or from the fact that failure and/or same change/remediation has been applied on a situation that had not been detected so far.

In unsupervised cases, it is possible that the two issues may be lumped together both in terms of the prediction but also later in terms of the remediation that would take or recommend strategies or automate an orchestration of an action that would fix the different underlying issues.

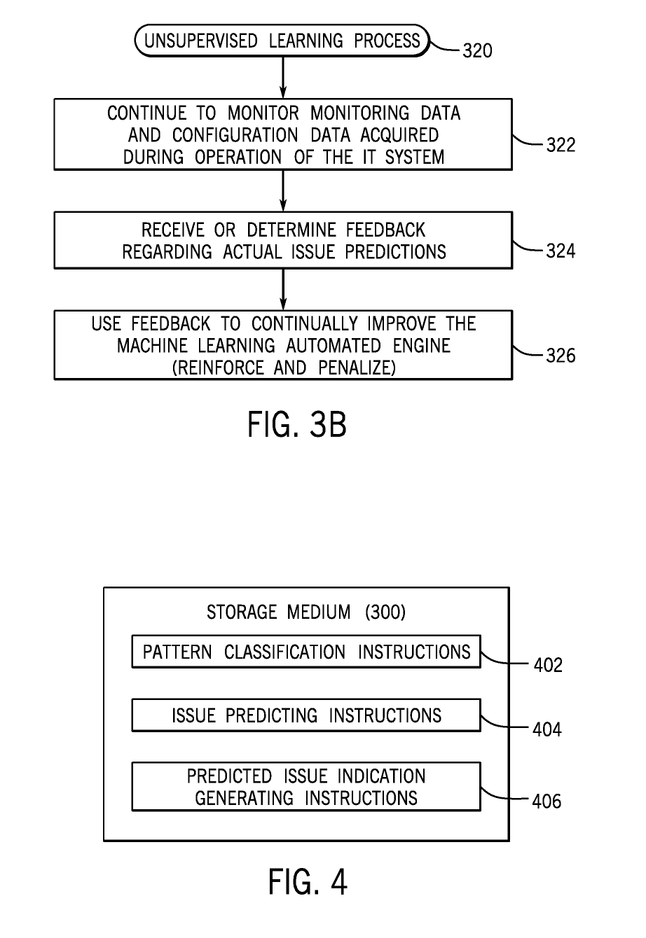

FIG. 4 is a block diagram of a non-transitory computer-readable or machine-readable storage medium 400 that stores machine-readable instructions that upon execution cause a system to perform various tasks.

In some examples, the machine-readable instructions stored on the storage medium 300 can be provided as a software, a service, or a solution offering (more generally referred to as a “customer-retrievable tool”). For example, the customer-retrievable tool can include a toolkit that can be retrieved from a website or cloud and downloaded to a customer's specific system. The customer-retrievable tool can be used to perform issue predictions and/or remediation as discussed. The customer-retrievable tool can be quickly leveraged by a user to predict issues in a system. Once the customer-retrievable tool is trained and validated, they can be deployed in the user's system to address potential issues, to provide a rapid way to address the issues.

A benefit of the customer-retrievable tool is that because the solution is for a given issue on a given system in a given environment or context, much less training data and much less complex algorithms are used to train the issue prediction system. Dealing with different issues can be done by running multiple instances of the issue prediction system in parallel (e.g. a containerized system for each issue), and/or with unsupervised training of the first system to expand its reach (may be more tricky for customers initially).

A further benefit of the approach is that the data (historic data) can now be pooled in one place (across issues, across context or environment or even across companies, with appropriate filtering or replacement of location data, IP data, or name specific information into placeholders. So a vendor of the issue prediction system can build more and more generic systems as well as build stronger remediation engines as there is better and more data.

The machine-readable instructions include pattern classification instructions 402 to use machine learning to perform a classification based on a pattern in collected monitoring data and configuration data of an IT system associated with an onset of an issue.

The machine-readable instructions further include issue predicting instructions 404 to predict, based on the classification, the issue before the issue occurs or before the issue is detected or reported. The machine-readable instructions additionally include predicted issue indication generating instructions 406 to generate an indication of the predicted issue. The generation of the indication of the predicted issue is independent of any end user reporting of the issue.

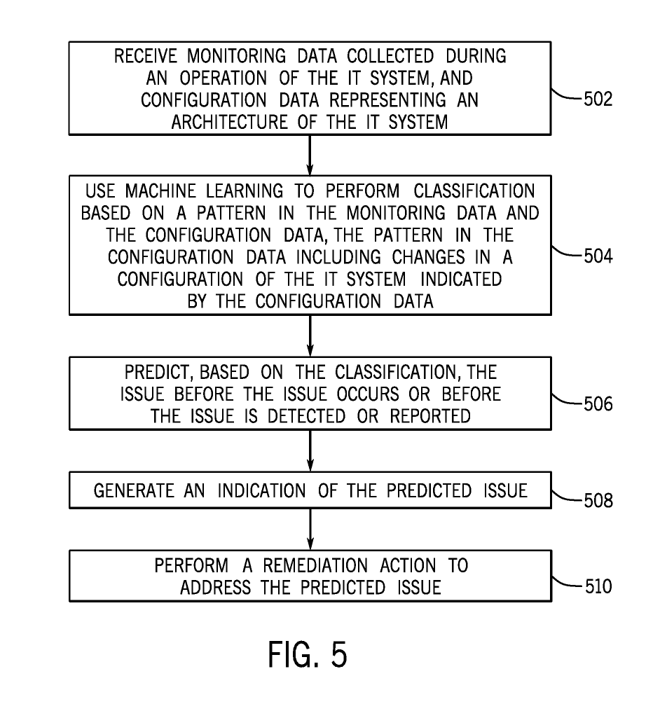

FIG. 5 is a flow diagram of a process according to some examples of the present disclosure. The process of FIG. 5 receives (at 502) monitoring data collected during an operation of the IT system, and configuration data representing an architecture of the IT system.

The process uses (at 504) machine learning to perform classification based on a pattern in the monitoring data and the configuration data, the pattern in the configuration data including changes in a configuration of the IT system indicated by the configuration data.

The process predicts (at 506), based on the classification, the issue before the issue occurs or before the issue is detected or reported. The process generates (at 508) an indication of the predicted issue.

The process further performs (at 510) a remediation action to address the predicted issue.

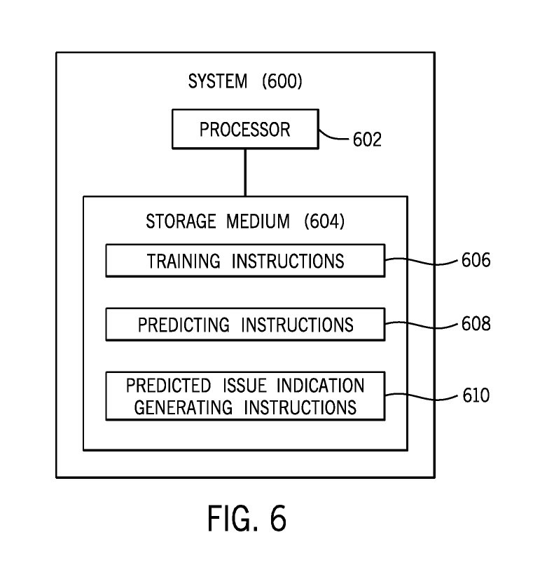

FIG. 6 is a block diagram of a system 600 according to further examples of the present disclosure. The system 600 includes a processor 602 (or multiple processors) and a non-transitory storage medium 604 storing machine-readable instructions executable on the processor 602 to perform various tasks. A processor can include a microprocessor, a core of a multi-core microprocessor, a microcontroller, a programmable integrated circuit, a programmable gate array, or another hardware processing circuit.

The machine-readable instructions include training instructions 606 to train a prediction engine (e.g., the machine learning automated engine 214 of FIG. 2) to detect an issue based on classification of pattern in collected monitoring data and configuration data of an IT system associated with an onset of an issue, where the monitoring data is collected during an operation of the IT system, and the configuration data represents an architecture of the IT system and changes in the IT system indicative of issues. The monitoring data and the configuration data are time-aligned.

The machine-readable instructions further include issue predicting instructions 608 to predict, by the prediction engine based on the classification, the issue before the issue occurs or before the issue is detected or reported. The machine-readable instructions further include predicted issue indication generating instructions 610 to generate an indication of the predicted issue.

The storage medium 400 (FIG. 4) or 604 (FIG. 6) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a system to:
using machine learning to perform a classification based on a pattern in collected monitoring data and configuration data of an information technology (IT) system associated with an onset of an issue, the monitoring data to be collected during an operation of the IT system, and the configuration data representing an architecture of the IT system;
predict, based on the classification, the issue before the issue occurs or before the issue is detected or reported; and
generate an indication of the predicted issue.

2. The non-transitory machine-readable storage medium of claim 1, wherein the configuration data representing the architecture of the IT system comprises configuration data that represents system resources of the IT system and a topology of the IT system and represents a setup of the system resources.

3. The non-transitory machine-readable storage medium of claim 1, wherein the instructions upon execution cause the system to:
train a prediction engine using the monitoring data and configuration data, the monitoring data and the configuration data including timestamps, and the configuration data to train the prediction engine or to partition the monitoring data into plural segments for respective different configurations, and
wherein the classification based on the pattern and the predicting of the issue are performed by the trained prediction engine.

4. The non-transitory machine-readable storage medium of claim 3, wherein the training of the prediction engine trains the prediction engine to associate classification of patterns to reported past issues using time aligned data including the monitoring data, the configuration data, and data representing the reported past issues.

5. The non-transitory machine-readable storage medium of claim 4, wherein the reported past issues are included in data selected from among IT service management (ITSM) data, configuration management system (CMS) data, data of a configuration management database (CMDB), or an operations log.

6. The non-transitory machine-readable storage medium of claim 4, wherein the training of the prediction engine comprises supervised training of the prediction engine using tickets in IT service management (ITSM) data to identify issues.

7. The non-transitory machine-readable storage medium of claim 3, wherein the training of the prediction engine comprises unsupervised training of the prediction engine during operation of the IT system for use by end users.

8. The non-transitory machine-readable storage medium of claim 7, wherein the unsupervised training of the prediction engine comprises receiving or determining feedback regarding whether or not actual predictions made by the prediction engine has been indicated as a false positive, a false negative, or a correct prediction.

9. The non-transitory machine-readable storage medium of claim 7, wherein the unsupervised training of the prediction engine comprises:
reinforcing a learning by the prediction engine if a predicted issue is acted upon;
penalizing a learning by the prediction engine if the predicted issue is not acted upon and the issue did not occur; and
reinforcing the learning if the predicted issue is not acted upon but the issue occurred.

10. The non-transitory machine-readable storage medium of claim 1, wherein the instructions upon execution cause the system to:
input the predicted issue as a ticket into an IT service management (IT) system; and
identify, by the ITSM system, an entity to resolve the predicted issue.

11. The non-transitory machine-readable storage medium of claim 1, wherein the monitoring data includes data relating to at least one selected from among data of an event in the IT system, data of a metric measured in the IT system, or a log that includes data collected by the IT system.

12. The non-transitory machine-readable storage medium of claim 1, wherein the generation of the indication of the predicted issue is independent of any end user reporting of the issue.

13. The non-transitory machine-readable storage medium of claim 1, wherein the instructions upon execution cause the system to perform a remediation task to address the predicted issue.

14. The non-transitory machine-readable storage medium of claim 13, wherein the remediation task comprises initiating an online chat session involving a plurality of participants, and to provide to the online chat session at least one selected from among: information of the predicted issue, information of a root cause of the predicted issue, information of a possible resolution for the predicted issue, and a past history relating to the predicted issue.

15. The non-transitory machine-readable storage medium of claim 13, wherein the remediation task comprises sending a notification to an entity or creating an IT service management (ITSM) ticket.

16. The non-transitory machine-readable storage medium of claim 13, wherein the remediation task comprises retrieving, from a historic actions repository, information pertaining to a matching issue that matches the predicted issue, the retrieved information comprising at least one selected from among a recommended remediation action or strategy, parameter information relating to automating the remediation task, and a heuristic rule that identifies a root cause given a situation relating to the predicted issue.

17. The non-transitory machine-readable storage medium of claim 1, wherein the remediation task is performed by an artificial intelligence system that generates a new remediation action, the artificial intelligence system to learn the new remediation action based on reasoning comprising examples on how implemented remediation of actual issues have been determined.

18. The non-transitory machine-readable storage medium of claim 1, wherein the monitoring data, the configuration data, and the indication of predicted issue are time aligned.

19. The non-transitory machine-readable storage medium of claim 1, wherein the monitoring data comprises IT service management (ITSM) data.

20. The non-transitory machine-readable storage medium of claim 1, wherein a change in configuration of the IT system is indicative of a new issue, and the instructions upon execution cause the system to train a classifier based on the change in configuration for the new issue.

21. The non-transitory machine-readable storage medium of claim 1, wherein the instructions are part of a customer-retrievable tool installable by a customer on the system of the customer, the customer-retrievable tool when executed on the system of the customer learning issues and predicting issues.

22. A method for an information technology (IT) system, comprising:
receiving monitoring data collected during an operation of the IT system, and configuration data representing an architecture of the IT system;
using machine learning to perform a classification based on a pattern in the monitoring data and the configuration data, the pattern in the configuration data including changes in a configuration of the IT system indicated by the configuration data;
predict, based on the classification, the issue before the issue occurs or before the issue is detected or reported;
generate an indication of the predicted issue; and
perform a remediation action to address the predicted issue.

23. The method of claim 22, wherein the changes in the configuration of the IT system were made to address a past issue.

24. A system comprising:
a processor; and
a non-transitory storage medium storing instructions executable on the processor to:
train a prediction engine to detect an issue based on classification of a pattern in collected monitoring data and configuration data of an information technology (IT) system associated with an onset of an issue, the monitoring data collected during an operation of the IT system, and the configuration data representing an architecture of the IT system and changes in the IT system indicative of issues, the monitoring data and the configuration data being time-aligned;
predict, by the prediction engine based on the classification, the issue before the issue occurs or before the issue is detected or reported; and
generate an indication of the predicted issue.
